(19) United States
(12) Patent Application Publication
(10) Pub. No.: US 2010/0320217 A1
(43) Pub. Date: Dec. 23, 2010

(54) BACKUP RING AND TANK WITH THE SAME

(76) Inventors: Eiji Okawachi, Aichi (JP); Tsukuo Ishitoya, Aichi (JP)

Correspondence Address: KENYON & KENYON LLP, 1500 K STREET N.W., SUITE 700, WASHINGTON, DC, 20005, US

(21) Appl. No.: 12/446,330

(22) PCT Filed: Oct. 30, 2007
(86) PCT No.: PCT/JP2007/071446

§ 371 Date: Apr. 20, 2009

(30) Foreign Application Priority Data
Nov. 1, 2006 (JP) 2006-297886

(51) Int. Cl. F16J 15/10; B65D 53/02

(52) U.S. Cl. 220/694; 277/638

(57) ABSTRACT

Provided is a backup ring capable of reinforcing a seal member such as an O-ring, preventing extrusion of the seal member, and preventing the backup ring from suddenly opening in its circumferential direction, thereby improving the sealability; and a tank equipped with such a backup ring is also provided. A backup ring is formed into a ring body by making a first cut surface and a second cut surface come into contact with each other wherein the cut surfaces are formed by cutting the backup ring. An engagement protrusion is formed on the first cut surface, while an engagement recess capable of engaging with the engagement protrusion is formed on the second cut surface so that the engagement protrusion can be attached to or detached from the engagement recess. When the engagement protrusion and the engagement recess engage with each other, the first cut surface is in contact with the second cut surface, so that circumferential movement of the second cut surface relative to the first cut surface is prevented.

### TECHNICAL FIELD

The present invention generally relates to an improvement of a backup ring that reinforces a seal member such as an O-ring and prevents, for example, extrusion of the seal member, and the invention also relates to an improvement of a tank equipped with such a backup ring.

### BACKGROUND ART

A backup ring has been conventionally used to reinforce a seal member such as an O-ring and prevent, for example, extrusion of the seal member. This backup ring is generally made of a relatively soft material such as Teflon (fluororesin), nylon (polyamide resin), synthetic resin, leather, hard rubber, or light metal in order to prevent damaging the O-ring. The circumference of the backup ring is cut at one position so that the backup ring can be opened and have its diameter made larger than the closed backup ring and the backup ring can be thereby easily attached to a mount part.

As an example of such a backup ring, a backup ring whose circumference is cut (bias-cut) at an acute angle (obliquely) to the radial direction thereof at one position so that the backup ring can be opened and the diameter of the opened backup ring can be made larger than the diameter of a mount part, thereby improving easy attachment to a mount groove, has been introduced. (See, for example, Japanese Patent Application Laid-Open (Kokai) Publication No. 2005-114007).

However, if high pressure is applied to such a conventional backup ring, there is a possibility that the cut portion may be opened and the O-ring may enter this opened portion, thereby damaging the O-ring or degrading the quality of its seal.

There is also a backup ring that has a female fastener element at one cut end of the backup ring and a male fastener element at the other cut end thereof, these cut ends formed by cutting the backup ring, wherein the female fastener element and the male fastener element are connected to each other through their mutual engagement therebetween so that the backup ring will not open radially. (See, for example, Japanese Utility Model Application Laid-Open (Kokai) Publication No. H6-20958).

Also, a lock ring structure that includes a shaft with a groove in its outside surface for supporting a moving member, and a ring member to be fit into the groove has been introduced, in which engagement portions that engage with each other are formed at both open ends of the ring member. (See, for example, Japanese Patent Application Laid-Open (Kokai) Publication No. H8-61341).

Furthermore, a backup ring with protruding and recessed ends formed by cutting the backup ring, in which the protruding and recessed ends are made to engage with each other, so that relative radial displacement of the ends can be prevented is also known. (See, for example, Japanese Utility Model Application Laid-Open (Kokai) Publication No. S58-65464).

However, the backup ring described in Japanese Utility Model Application Laid-Open (Kokai) Publication No. H6-20958 is designed so that the cut ends are bound to each other by engaging the female fastener element and male fastener element formed on the respective cut ends so that the backup ring will not open radially; and no consideration is given to prevention of the backup ring from opening in its circumferential direction. The O-ring is placed on a surface of the backup ring where the cut line (boundary) formed between the female and male fastener elements when the female fastener element engages with the male fastener element is exposed. If a height difference is formed at the cut line portion between the female and male fastener elements, a burden will be placed on the O-ring. Since the cut line of the backup ring described in Japanese Utility Model Application Laid-Open (Kokai) Publication No. H6-20958 is longer and has a more complicated shape than a straight cut line formed by cut ends of a backup ring without any female or male elements, a larger burden may possibly be placed on the O-ring than the case of the straight cut line.

The lock ring described in Japanese Patent Application Laid-Open (Kokai) Publication No. H8-61341 is designed to control movement of a pinion gear that constitutes a moving member, or to lock the axial movement of a shaft, but the lock ring is not intended to be used as a backup ring in order to reinforce an O-ring or prevent extrusion of the O-ring. Therefore, as a matter of course, no inventive idea has been devised to use the lock ring together with the O-ring, for example, by giving consideration to sealability and avoiding burden on the O-ring.

Furthermore, the backup ring described in Japanese Utility Model Application Laid-Open (Kokai) Publication No. S58-65464 can prevent relative radial displacement between the cut ends of a backup ring, but no consideration has been given to prevention of the backup ring opening in the circumferential direction.

### DISCLOSURE OF THE INVENTION

The present invention was devised in light of the circumstances described above. It is an object of the invention to provide: a backup ring capable of not only reinforcing a seal member such as an O-ring and preventing, for example, extrusion of the seal member, but also preventing the backup ring from suddenly opening in its circumferential direction, thereby improving the sealability of the backup ring; and a tank equipped with such a backup ring. In order to achieve the above-described object, provided according to an aspect of the invention is a backup ring formed into the shape of a ring body by having a first cut surface thereof come into contact with a second cut surface thereof, the cut surfaces being formed by cutting the backup ring, wherein a first engagement portion is formed on the first cut surface, and a second engagement portion is formed on the second cut surface in such a manner that: the second engagement portion engages with the first engagement portion so that the second engagement portion can be attached to or detached from the first engagement portion; and when the send engagement portion engages with the first engagement portion, the first cut surface comes into contact with the second cut surface and circumferential movement of the second cut surface relative to the first cut surface is prevented.

The backup ring having the above-described configuration is formed into the shape of a ring body when the first engagement portion formed on the first cut surface engages with the second engagement portion formed on the second cut surface. When the backup ring takes the shape of the ring body, circumferential movement of the second cut surface relative to the first cut surface can be prevented. Therefore, it is possible to prevent the backup ring when in use from suddenly opening in its circumferential direction and have it always keep an optimum ring shape.

The backup ring according to this invention can be configured so that the first cut surface and the second cut surface have areas that overlap with each other in an axial direction of the backup ring. In this case, the first engagement portion and the second engagement portion can be formed in the areas that overlap with each other in the axial direction of the backup ring. If the backup ring is configured in the above-described manner, the first engagement portion and the second engagement portion will not be formed on the surface(s) in the axial direction(s) of the backup ring. As a result, only the cut line formed by cutting the backup ring will appear on the surface(s) in the axial direction(s) of the backup ring. Therefore, even if this cut line puts a certain degree of burden on a seal member such as an O-ring that is placed on this surface, it is possible to minimize the burden.

Furthermore, the backup ring according to this invention can be configured so that when the first engagement portion engages with the second engagement portion, a surface of the ring body in the axial direction becomes a flat surface. In other words, when the first cut surface and the second cut surface are made to be in contact with each other to form the ring body, it is possible to prevent a height difference from being formed at the boundary between the first cut surface and the second cut surface on the surface(s) in the axial direction(s) of the backup ring. As a result, the above-described configuration will not have an adverse effect on a seal member such as an O-ring that is placed on that surface.

The backup ring according to this invention can be configured so that a third engagement portion is further formed on the first cut surface, and a fourth engagement portion is formed on the second cut surface in such a manner that: the fourth engagement portion engages with the third engagement portion so that the fourth engagement portion can be attached to or detached from the third engagement portion; and when the fourth engagement portion engages with the third engagement portion, circumferential movement of the second cut surface relative to the first cut surface is prevented. With the backup ring having the above-described configuration, the circumferential movement of both the cut surfaces relative to each other is prevented with certainty by engagement of the first engagement portion with the second engagement portion and engagement of the third engagement portion with the fourth engagement portion. As a result, it is possible to reliably prevent the backup ring when in use from suddenly opening in its circumferential direction.

In the above-described configuration, the third engagement portion and the fourth engagement portion can be formed in areas that overlap with each other in the axial direction of the backup ring. Because of this configuration, the third engagement portion and the fourth engagement portion will not be formed on the surface(s) in the axial direction(s) of the backup ring and only the cut line formed by cutting the backup ring appears on the surface(s) in the axial direction(s) of the backup ring. As a result, even if this cut line puts a certain degree of burden on a seal member such as an O-ring that is placed on this surface, it is possible to minimize the burden.

The invention also provides a tank equipped with the aforementioned backup ring according to the invention. Since the backup ring for this tank does not suddenly open in its circumferential direction, it is possible for the backup ring to be in its optimum state when it is in contact with a seal member, such as an O-ring, that is placed together with the backup ring. As a result, the life of the seal member can be extended and its seal quality can be improved.

### BRIEF DESCRIPTION OF THE DRAWINGS

FIG. 1 is a perspective view of a backup ring according to an embodiment of the present invention;

FIG. 2 is an enlarged side view of a cut portion and its adjacent area of the backup ring shown in FIG. 1;

FIG. 3 is a side view illustrating the state where the cut portion of the backup ring shown in FIG. 2 is opened;

FIG. 4 is a side view illustrating the state where the backup ring shown in FIG. 1 is used on a gas supply port of a tank;

FIG. 5 is a partly sectional view illustrating the state where the tank shown in FIG. 4 is connected to a pipe;

FIG. 6 is an enlarged side view of a cut portion and its adjacent area of a backup ring according to another embodiment of the invention;

FIG. 7 is an enlarged side view of a cut portion and its adjacent area of a backup ring according to another embodiment of the invention;

FIG. 8 is an enlarged side view of a cut portion and its adjacent area of a backup ring according to another embodiment of the invention;

FIG. 9 is an enlarged side view of a cut portion and its adjacent area of a backup ring according to another embodiment of the invention; and

FIG. 10 is a perspective view of a backup ring according to another embodiment of the invention.

### BEST MODE FOR CARRYING OUT THE INVENTION

Next, a backup ring and a tank equipped with this backup ring according to preferred embodiments of the present invention will be explained below with reference to the attached drawings. While the embodiments described below are for the purpose of describing this invention, the invention is not limited only to these embodiments. Accordingly, this invention can be utilized in various ways unless the utilizations depart from the gist of the invention.

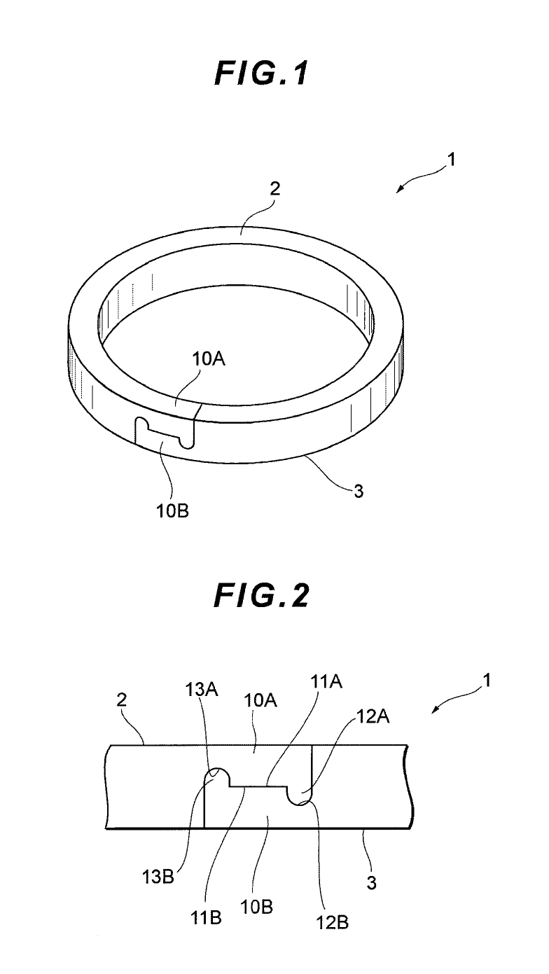

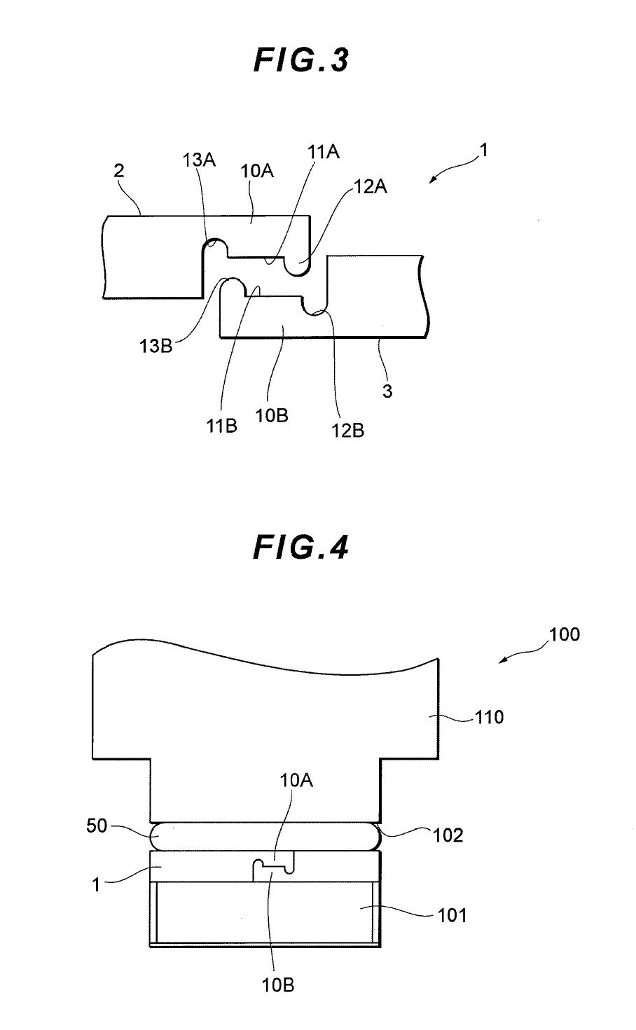

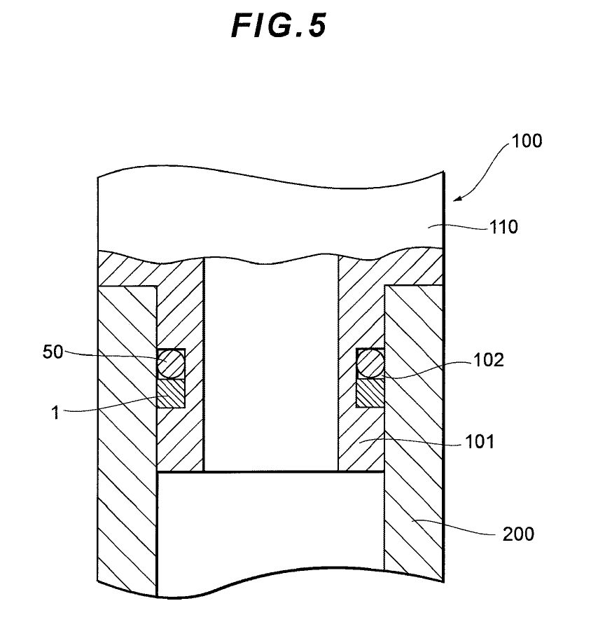

FIG. 1 is a perspective view of a backup ring according to an embodiment of the present invention; FIG. 2 is an enlarged side view of a cut portion and its adjacent area of the backup ring shown in FIG. 1; FIG. 3 is a side view illustrating the state where the cut portion of the backup ring shown in FIG. 2 is opened; FIG. 4 is a side view illustrating the state where the backup ring shown in FIG. 1 is used on a tank; and FIG. 5 is a partly sectional view illustrating the state where the tank shown in FIG. 4 is connected to a pipe.

Incidentally, each of the above drawings illustrates the thickness, size, enlargement and reduction ratios, and other details of each component; but for ease of comprehension, they are not to scale. Furthermore, the direction perpendicular to a radial direction of the backup ring is defined as the “axial direction” of the backup ring according to embodiments of the invention.

As shown in FIGS. 1 to FIG. 3, a backup ring 1 according to an embodiment of the present invention is configured so that the ring body is cut at one position. One end 10A of the backup ring 1 formed by cutting the backup ring 1 has a cut surface 11A formed by cutting the backup ring 1, while the other end 10B has a cut surface 11B. The cut surface 11A and the second cut surface 11B have areas that overlap with each other in an axial direction.

An engagement protrusion 12A protruding in an axial direction and an engagement recess 13A that is located a certain distance from the engagement protrusion 12A and is recessed in the direction opposite the direction of protrusion of the engagement protrusion 12A are formed in an area of the cut surface 11A that overlaps with the cut surface 11B in an axial direction. Meanwhile, an engagement recess 12B capable of engaging with the engagement protrusion 12A so that the engagement protrusion 12A can be attached to or detached from the engagement recess 12B is formed in an area of the cut surface 11B that overlaps with the cut surface 11A in an axial direction, at a position opposite the engagement protrusion 12A when the cut surface 11A and the cut surface 11B are in contact with each other (i.e., when the backup ring 1 is made to take the shape of a ring); and an engagement protrusion 13B capable of engaging with the engagement recess 13A so that it can be attached to or detached from the engagement recess 13A is formed at a position opposite the engagement recess 13A. Incidentally, in this embodiment, the engagement protrusion 12A, the engagement recess 12B, the engagement protrusion 13B, and the engagement recess 13A are formed by cutting the backup ring 1 and constitute part of the cut surface 11A and the cut surface 11B. Therefore, the engagement recess 12B has a shape that complements that of the engagement protrusion 12A, and the engagement protrusion 13B has a shape that complements that of the engagement recess 13A. When the engagement protrusion 12A engages with the engagement recess 12B and the engagement protrusion 13B engages with the engagement recess 13A, both surfaces 2 and 3 of the backup ring 1 in the axial directions can become flat planes.

When the backup ring 1 having the above-described configuration is made to take the ring shape by making the cut surface 11A and the cut surface 11B in contact with each other, the engagement protrusion 12A engages with the engagement recess 12B and the engagement protrusion 13B engages with the engagement recess 13A, so that the engagement protrusions 12A, 13B and the engagement recesses 12B, 13A are locked in position by each other. Accordingly, circumferential movement of the cut surface 11A relative to the cut surface 11B can be prevented. As a result, since the backup ring 1 can be prevented from suddenly opening in the circumferential direction, it is possible to prevent a gap from being formed in the contact area (i.e., the cut portion) between the cut surface 11A and the cut surface 11B.

When a tank 100 is connected to a pipe 200 as shown in FIGS. 4 and 5, the backup ring 1 together with an O-ring 50 is placed in a ring groove 102 formed around the outside surface of a gas supply port 101 for a tank body 110. Incidentally, the backup ring 1 is placed at a position closer to the pipe 200 where the pressure is lower than the position where the O-ring 50 is placed. Since with the tank 100 on which the backup ring 1 is placed the backup ring 1 is prevented from suddenly opening in its circumferential direction as described above, hardly any gap will form in the contact area (i.e., the cut portion) between the cut surface 11A and the cut surface 11B. As a result, the backup ring 1 always keeps the optimum state and, at the same time, reinforces the O-ring 50 and prevents extrusion of the O-ring 50. On the surface 2 (or 3) of the backup ring 1 in contact with the O-ring 50, a height difference or the like will be hardly formed at the boundary between the cut surface 11 A and the cut surface 11 B of the backup ring 1, so the surface 2 (or 3) will be kept flat, which will not have any adverse effect on the O-ring 50. As a result, the life of the O-ring 50 can be extended and the quality of its seal can be improved.

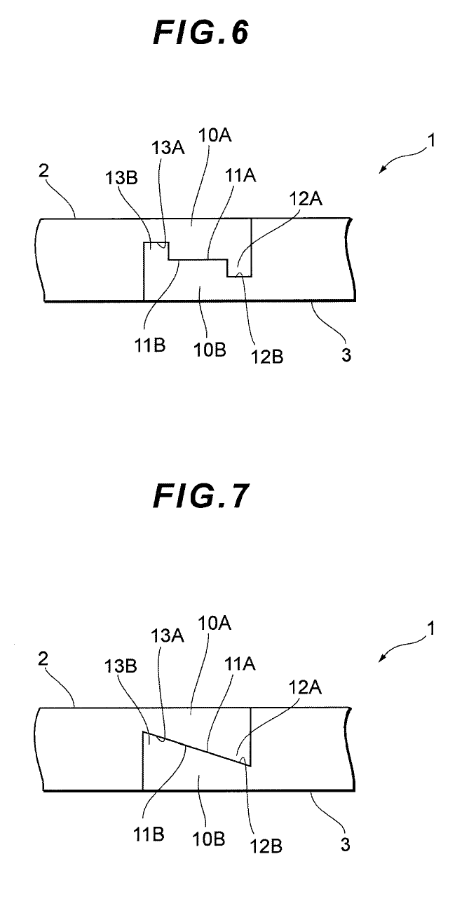

Incidentally, each of the engagement protrusions 12A, 13B and the engagement recesses 12B, 13A has a shape with rounded corners in this embodiment. However, the shape of the engagement protrusions 12A, 13B and the engagement recesses 12B, 13A is not limited to this example, and they may be formed into a shape with angled corners as shown in FIG. 6 or may be tapered as shown in FIG. 7. There is no particular limitation on the shape of the engagement protrusions 12A, 13B and the engagement recesses 12B, 13A as long as the backup ring 1 can be prevented from suddenly opening in its circumferential direction when the engagement protrusion 12A engages with the engagement recess 12B and the engagement protrusion 13B engages with the engagement recess 13A.

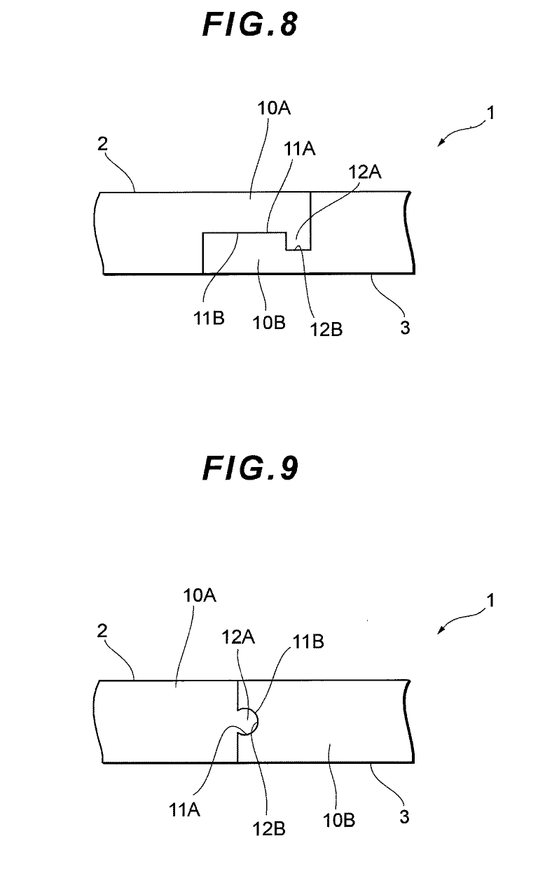

This embodiment has described the case where the engagement protrusion 12A (first engagement portion) and the engagement recess 12B (second engagement portion) to engage with the engagement protrusion 12A as well as the engagement protrusion 13B (third engagement portion) and the engagement recess 13A (fourth engagement portion) to engage with the engagement protrusion 13B are formed. However, the configuration of the backup ring 1 is not limited to this example, and only the engagement protrusion 12A (first engagement portion) and the engagement recess 12B (second engagement portion) to engage with the engagement protrusion 12A may be formed if desired, as shown in FIG. 8. Furthermore, as shown in FIG. 9, the engagement protrusion 12A may be formed on the end face of the end 10A, while the engagement recess 12B may be formed on the end face of the end 10B. In the configuration shown in FIG. 9, it is possible to prevent the backup ring 1 from suddenly opening in its circumferential direction by making the base end side of the engagement protrusion 12A narrower than the maximum diameter portion of the engagement protrusion 12A (as a result, the engagement recess 12B is formed into a curved dovetail groove shape).

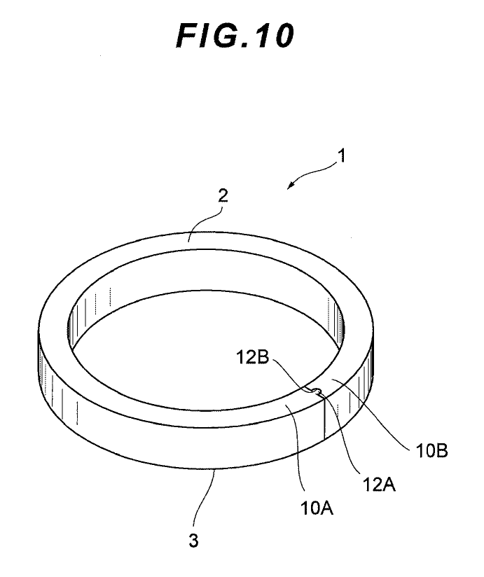

Furthermore, the positions where the engagement protrusion 12A, the engagement recess 12B, the engagement protrusion 13B, and the engagement recess 13A described above are formed may be decided arbitrarily. Even if the surface of the backup ring 1 in contact with the O-ring 50 is slightly uneven, unless the unevenness will have an adverse effect on the O-ring 50, the engagement protrusion 12A and the engagement recess 12B (the engagement protrusion 13B and the engagement recess 13A) may be formed so that they are exposed on the surface 2 (3) as shown in FIG. 10. In this case, it is preferable to form the engagement protrusion 12A and the engagement recess 12B (the engagement protrusion 13B and the engagement recess 13A) so that there will be no height difference at the boundary between the cut surface 11A and the cut surface 11B.

### INDUSTRIAL APPLICABILITY

The first engagement portion and the second engagement portion of the backup ring according to the present invention engage with each other so that the backup ring will not suddenly open in its circumferential direction. Therefore, the backup ring can be in the optimum state when it is in contact with a seal member, such as an O-ring, that is placed together with the backup ring. As a result, the backup ring can not only reinforce the seal member and prevent, for example, extrusion of the seal member, but also extend the life of the seal member and improve the quality of its seal.

Furthermore, with the tank according to the present invention, the backup ring, which is a component of the tank, will not suddenly open in its circumferential direction. Therefore, the backup ring will be in the optimum state when it is in contact with a seal member such as an O-ring that is placed together with the backup ring. As a result, the life of the seal member can be extended, the quality of its seal can be improved, and a highly reliable tank can be provided.

1. A backup ring formed into the shape of a ring body by having a first cut surface thereof come into contact with a second cut surface thereof, the cut surfaces being formed by cutting the backup ring,
wherein a first engagement portion is formed on the first cut surface, and
a second engagement portion is formed on the second cut surface in such a manner that: the second engagement portion engages with the first engagement portion so that the second engagement portion can be attached to or detached from the first engagement portion; and when the send engagement portion engages with the first engagement portion, the first cut surface comes into contact with the second cut surface and circumferential movement of the second cut surface relative to the first cut surface is prevented, and
each of the first engagement portion and the second engagement portion protrudes in an axial direction of the ring body.

2. The backup ring according to claim 1, wherein the first cut surface and the second cut surface have areas that overlap with each other in an axial direction of the backup ring.

3. The backup ring according to claim 2, wherein the first engagement portion and the second engagement portion are formed in the areas that overlap with each other in the axial direction of the backup ring.

4. The backup ring according to claim 1, wherein when the first engagement portion engages with the second engagement portion, a surface of the ring body in the axial direction becomes a flat surface.

5. The backup ring according to claim 1, wherein a third engagement portion is formed on the first cut surface, and
a fourth engagement portion is formed on the second cut surface in such a manner that: the fourth engagement portion engages with the third engagement portion so that the fourth engagement portion can be attached to or detached from the third engagement portion; and when the fourth engagement portion engages with the third engagement portion, circumferential movement of the second cut surface relative to the first cut surface is prevented.

6. The backup ring according to claim 5, wherein the third engagement portion and the fourth engagement portion are formed in areas that overlap with each other in the axial direction of the backup ring.

7. A tank equipped with the backup ring described in claim 1.
